(19) United States
(12) Patent Application Publication
(10) Pub. No.: US 2002/0070242 A1
(43) Pub. Date: Jun. 13, 2002

(54) Fluid dispenser

(75) Inventor: Marisol Simard, Nyack, NY (US)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: VALOIS S.A.

(21) Appl. No.: 10/003,524

(22) Filed: Dec. 6, 2001

(30) Foreign Application Priority Data
Dec. 8, 2000 (FR) 00 15997

(51) Int. Cl. G01F 11/06

(52) U.S. Cl. 222/321.9

(57) ABSTRACT

A fluid dispenser comprising:

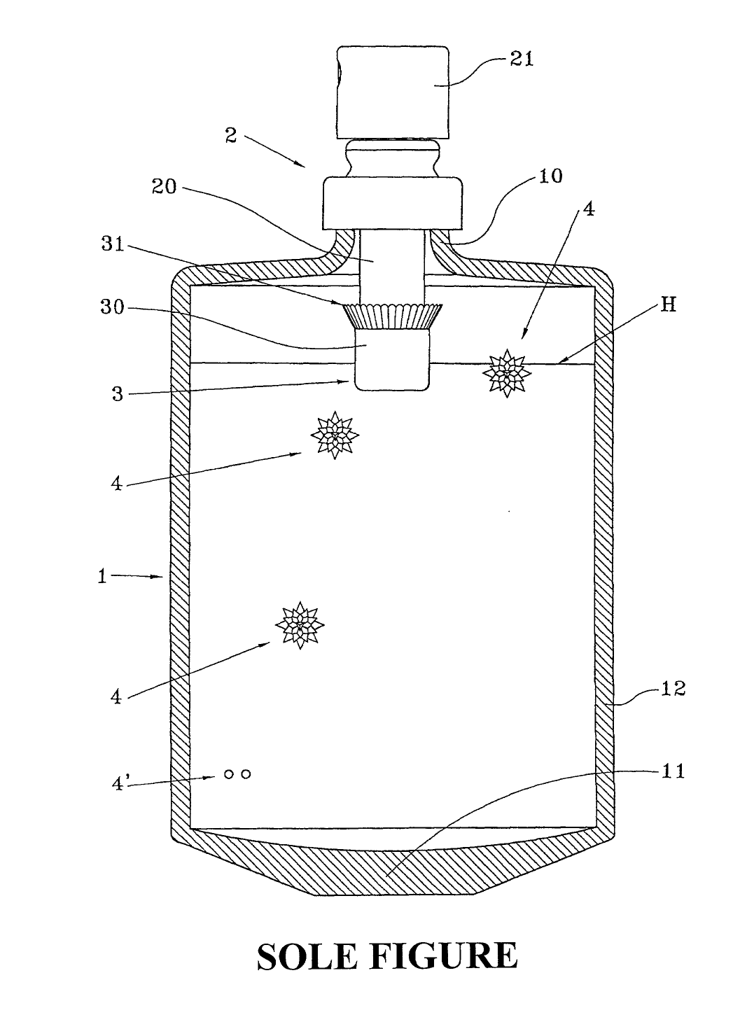

a fluid reservoir forming a neck; and

a dispensing member having an inlet engaged in the neck, said member being provided with a fluid retention system mounted in place of a dip tube, and for retaining a certain quantity of fluid in the vicinity of the inlet of said member, said dispensing member drawing off fluid from said retention system each time the dispenser is actuated, said retention system being refilled by shaking said dispenser;

wherein shake incitation means are provided to incite the user to shake the dispenser.

### FIELD OF THE INVENTION

The present invention relates to a fluid dispenser comprising a reservoir serving to contain the fluid, and a dispensing member, such as a pump or a valve, mounted on the opening in the reservoir, which opening is usually in the form of a neck. In general, the pump or the valve is engaged in the neck, and the top portion of the pump or the valve forms a pusher which can be pressed to actuate it, thereby dispensing fluid from the reservoir. This type of dispenser is in frequent use in the fields of perfumes, cosmetics, and pharmaceuticals.

The present invention is applicable more particularly to a type of fluid dispenser that incorporates a fluid retention system mounted in place of a dip tube and for retaining a certain quantity of fluid in the vicinity of the inlet of the pump or of the valve. Thus, each time the dispenser is actuated, fluid is drawn off from the retention system. To refill the retention system, it is necessary merely to shake the dispenser.

### BACKGROUND OF THE INVENTION

Such a retention system is described in particular in Document EP 0 626 321, which is incorporated herein by way of reference. The retention system described in that document comprises a dish disposed below the inlet of the dispensing member, and above the surface of the fluid when the dispenser is in the upright position. The dispensing member is not provided with a dip tube, and it draws off fluid directly via its inlet from inside the dish. When the dish is empty, it is possible to fill it by turning the dispenser upside down or by shaking it so as to bring the fluid contained in the reservoir into the dish.

That retention system is disposed in the vicinity of the dispensing member or more precisely just below it. The capacity of its dish is small, since it cannot be too long for reasons of aesthetic appearance, and since it cannot be too wide because it must pass through the neck of the reservoir. That retention system is thus small in size so that the user hardly notices or does not notice at all that the dispensing member is equipped with such a retention system. After the dispenser has been actuated a few times, the dish is empty and the user might think that the dispensing member is no longer functioning properly or at all.

In addition, it is preferable for the retention system to be filled before the dispenser is used, so as to ensure that a full metered quantity is dispensed. The user must therefore shake the dispenser or turn it upside down before it is used, and every time it is used. But in general, the user does not do so, because the user does not know that the dispensing member is provided with a retention system.

### OBJECT AND SUMMARY OF THE INVENTION

The present invention proposes to remedy that drawback of the prior art by providing shake incitation means to incite the user to shake, or turn upside down the dispenser. Thus, the user automatically shakes the dispenser or turns it upside down without even knowing that it is provided with a fluid retention system as described above. While users think they are merely generating an aesthetically-pleasing or attractive effect, they are actually performing a functional operation of filling the dish of the retention system. In other words, the fun aspect imparted by the incitation means is used to bring users to shake the dispenser so as to fill the dish of the retention system even without them being aware that they are doing so.

In an embodiment, at least one shake incitation element is disposed in the reservoir to incite the user to shake the dispenser or to turn it upside down.

The incitation elements may be in a wide variety of forms. For example, they may be moveable in the reservoir, i.e. in the fluid, on the surface of the fluid, or in the space of the reservoir that is not occupied by the fluid. The incitation elements may be elements that float or that float at least to some extent, or they may remain momentarily in suspension in the fluid.

It is also possible to consider other forms of incitation means, e.g. provided on the reservoir, or in the material of which the reservoir is made, on its bottom or on its side walls. The incitation means may be provided on the dispensing member, e.g. on the pusher.

### BRIEF DESCRIPTION OF THE DRAWING

The accompanying sole FIGURE shows an embodiment of a fluid dispenser of the invention.

### MORE DETAILED DESCRIPTION

The dispenser comprises a reservoir 1 forming a neck 10, a bottom 11 on which the dispenser stands, and side walls 12. The reservoir 1 is made of a transparent material, e.g. glass.

A dispensing member 2, which may be a pump or a valve, is mounted on the neck 10 with the body 20 of the dispensing member extending inside the neck 10. At its top end, the dispensing member 2 is provided with a pusher 21 which is pressed to actuate the dispensing member and thereby to dispense a metered quantity of fluid. The dispensing member 2 is provided with a fluid retention system 3 at its inlet situated at the bottom end of the body 20. The fluid retention system 3 may be similar or identical to the system described in above-mentioned Document EP 0 626 321. It comprises a dish 30 in which the inlet of the dispensing member 2 is disposed. To improve the fluid retention and the filling of the dish 30, said dish may advantageously be provided with a collar 31.

When the reservoir 1 is filled with fluid, the level H of the fluid in the reservoir (when said reservoir is standing on its bottom 11) can come above the top edge of the dish 30 of the retention system 3. The dish 30 is then fully immersed in the fluid. It is also possible for the level H of the fluid in the reservoir not to reach the top end of the dish 30, so that said dish cannot be filled automatically with fluid. It is even possible for the dish 30 to be disposed above the level H of the fluid in the reservoir, even when the reservoir is full. In any event, as the fluid is dispensed by the dispensing member, the level H of the fluid in the reservoir falls, and unfailingly the situation is reached in which the dish 30 of the retention system is no longer in contact at all with the fluid in the reservoir when said reservoir is standing on its bottom 11.

The shake incitation means are, in this example, in the form of incitation elements 4, 4′ disposed in the reservoir 1 and visible by the user through the transparent side walls 12. The incitation elements 4, 4′ are totally or partially immersed in the fluid contained in the reservoir 1 whose level is represented by the line H. The incitation elements 4, 4′ may be floating elements, in particular floating or in suspension in the fluid. At rest, the incitation elements 4, 4′ may lie at the bottom 11 of the reservoir or else float at the level of the surface H of the fluid in the reservoir. When a user sees such a dispenser, the user understands immediately, on seeing the incitation elements, that it is necessary to shake the dispenser in order to put the incitation elements in motion in the reservoir, thereby obtaining an aesthetically-pleasing or attractive effect. The user therefore takes hold of the dispenser and starts by shaking it even before it is used for the first time. In so doing, the user causes the dish 30 of the retention system 3 to be filled with fluid.

The incitation means, which are in the form of floating elements or elements in suspension in this example, are disposed in the reservoir. The incitation means may also be disposed on the reservoir, e.g. on its side walls 12 or on its bottom 11.

Such incitation means provided on the bottom are advantageous because the user automatically turns the dispenser upside down in order to look at its bottom. The incitation means can then be in any form making it possible to attract the attention of the user to the bottom of the dispenser, and to arouse the curiosity of the user about said bottom of the dispenser.

The incitation means may, for example, be in the form of a change of color of a portion of the dispenser that is obtained by shaking the dispenser.

1/ A fluid dispenser comprising:
a fluid reservoir forming a neck; and
a dispensing member having an inlet engaged in the neck, said member being provided with a fluid retention system mounted in place of a dip tube, and for retaining a certain quantity of fluid in the vicinity of the inlet of said member, said dispensing member drawing off fluid from said retention system each time the dispenser is actuated, said retention system being refilled by shaking said dispenser;
wherein shake incitation means are provided to incite the user to shake the dispenser.

2/ A dispenser according to claim 1, in which the reservoir is transparent and the incitation means comprise at least one shake incitation element disposed in the reservoir to incite a user to shake the dispenser.

3/ A dispenser according to claim 2, in which the incitation element is moveable in the reservoir.

4/ A dispenser according to claim 2, in which the incitation element is moveable in the fluid contained in the reservoir.

5/ A dispenser according to claim 2, in which the incitation element is an element that floats, at least to some extent.

6/ A dispenser according to claim 2, in which the incitation element is in suspension in the fluid.
